(19) United States
(12) Patent Application Publication
(10) Pub. No.: US 2026/0099664 A1
(43) Pub. Date: Apr. 9, 2026

(54) Award Recommendation Letter Drafting Systems and Related Methods

(71) Applicant: Academic Analytics, L.L.C., Charlotte, NC (US)

(72) Inventors: Peter Lange, Durham, NC (US); Anthony Olejniczak, Columbus, OH (US)

(73) Assignee: Academic Analytics, L.L.C., Charlotte, NC (US)

(21) Appl. No.: 19/352,755

(22) Filed: Oct. 8, 2025

Related U.S. Application Data
(60) Provisional application No. 63/705,030, filed on Oct. 8, 2024.

(51) Int. Cl. G06F 40/166; G06F 40/103; G06F 40/40

(52) U.S. Cl. CPC G06F 40/166; G06F 40/103; G06F 40/40

(57) ABSTRACT

Implementations of a method of forming a draft recommendation letter for an award may include, receiving a selection of a researcher; determining at least one award the researcher may be eligible for using an awards database; displaying the at least one award; receiving a selection of the at least one award; in response, using a trained model, identifying a set of specifically relevant scholarly works or specifically relevant recognitions; generating an academically formatted list of the specifically relevant scholarly works or specifically relevant recognitions; generating a set of adaptable passages; generating a set of recommended characteristics; generating recommendation text; outputting the recommendation text, the set of adaptable passages, the set of recommended characteristics, and the academically formatted list of scholarly works or recognitions as a draft recommendation letter; and providing the draft recommendation letter in a user editable format configured for the user to submit to an awards committee.

### CROSS REFERENCE TO RELATED APPLICATIONS

This document claims the benefit of the filing date of U.S. Provisional Patent Application 63/705,030, entitled “Award Recommendation Letter Drafting Systems and Related Methods” to Lange et al. which was filed on Oct. 8, 2024 (the '030 Provisional), the disclosure of which is hereby incorporated entirely herein by reference.

### BACKGROUND

### 1. Technical Field

Aspects of this document relate generally to systems and methods used for creating recommendation letters for academic awards. More specific implementations involve systems and methods for generating recommendations letters using trained artificial intelligence models and an awards database.

### 2. Background

Academic awards are given to researchers, professors, and other academicians after an evaluation process conducted by an awards committee. Awards are typically academic discipline specific.

### SUMMARY

Implementations of a method of forming a draft recommendation letter for an award may include, using a processor, receiving a selection of a researcher using a first computer interface; determining at least one award the researcher may be eligible for using an awards database and the processor; and displaying the at least one award using a second computer interface. The method may include receiving a selection of the at least one award from a user using the second computer interface and, in response to receiving the selection of the at least one award, using the processor and a trained model, using the awards database, identifying a set of specifically relevant scholarly works or specifically relevant recognitions for the at least one award from a set of recent scholarly works authored by the researcher or received by the researcher. The method also may include generating an academically formatted list of the specifically relevant scholarly works or specifically relevant recognitions; generating a set of adaptable passages relevant to the award; generating a set of recommended characteristics for the researcher relevant to the award; generating recommendation text; and outputting, in a recommendation letter format, the recommendation text, the set of adaptable passages, the set of recommended characteristics, and the academically formatted list of the specifically relevant scholarly works or specifically relevant recognitions as a draft recommendation letter. The method also may include providing the draft recommendation letter to a computing device associated with the user in a user editable format configured for the user to finalize and submit to an awards committee.

Implementations of a method of forming a draft recommendation letter for an award may include one, all, or any of the following:

The method may include, in response to a selection from the user on the second computer interface, displaying one or more of the specifically relevant scholarly works or specifically relevant recognitions of the researcher using a third computer interface.

The trained model may be a special purpose model trained to generate recommendation text.

The trained model may be a general purpose model trained to perform the outputting.

The trained model may be a large language model.

The set of adaptable passages appear in the draft recommendation letter with an adaption indicator to prompt the user to update them.

The set of recommended characteristics appear in the draft recommendation letter with an adaption indicator to prompt the user to draft content describing one or more of the set of recommended characteristics.

The method may include wherein, before outputting, a third computer interface displays a prompt including the set of adaptable passages and the set of recommended characteristics.

The user may customize the prompt before submitting the prompt for processing by the processor and the trained model to output the recommendation text.

Implementations of a system for forming a draft recommendation letter for an award may include a processor operatively coupled with a memory, the processor and memory configured to receive a selection of a researcher using a first computer interface; determine at least one award the researcher may be eligible for using an awards database; and display the at least one award using a second computer interface. The processor and the memory of the system may be further configured to receive a selection of the at least one award from a user using the second computer interface; in response to receiving the selection of the at least one award, with a trained model, using the awards database, identify a set of specifically relevant scholarly works or specifically relevant recognitions for the at least one award from a set of recent scholarly works authored by the researcher or received by the researcher; and generate an academically formatted list of the specifically relevant scholarly works or specifically relevant recognitions. The processor and the memory may be further configured to generate a set of adaptable passages relevant to the award; generate a set of recommended characteristics for the researcher relevant to the award; generate recommendation text; and output, in a recommendation letter format, the recommendation text, the set of adaptable passages, the set of recommended characteristics, and the academically formatted list of the specifically relevant scholarly works or specifically relevant recognitions as a draft recommendation letter; and provide the draft recommendation letter to a computing device associated with the user in a user editable format configured for the user to finalize and submit to an awards committee.

Implementations of a system for forming a draft recommendation letter for an award may include one, all, or any of the following:

The system may include, in response to a selection from the user on the second computer interface, displaying one or more of the specifically relevant scholarly works or specifically relevant recognitions of the researcher using a third computer interface.

The trained model may be a special purpose model trained to generate recommendation text.

The trained model may be a general purpose model trained to perform the outputting.

The trained model may be a large language model.

The set of adaptable passages may appear in the draft recommendation letter with an adaption indicator to prompt the user to update them.

The set of recommended characteristics may appear in the draft recommendation letter with an adaption indicator to prompt the user to draft content describing one or more of the set of recommended characteristics.

The system may include wherein, before outputting, a third computer interface displays a prompt including the set of adaptable passages and the set of recommended characteristics.

The user may customize the prompt before submitting the prompt for processing by the processor and the trained model to output the recommendation text.

Implementations of a system for forming a draft recommendation letter for an award may include a processor operatively coupled with a memory, the processor and memory configured to receive a selection of a researcher; determine at least one award the researcher may be eligible for using an awards database; display the at least one award; receive a selection of the at least one award from a user; and in response to receiving the selection of the at least one award, generating a prompt configured for use by a trained model by, using the awards database, identifying a set of specifically relevant scholarly works or specifically relevant recognitions for the at least one award from a set of recent scholarly works authored by the researcher or received by the researcher. The system may further include generating an academically formatted list of the specifically relevant scholarly works or specifically relevant recognitions; generating a set of adaptable passages relevant to the award; and generating a set of recommended characteristics for the researcher relevant to the award; and forwarding the prompt to the trained model. The system may include receiving from the trained model, in a recommendation letter format, recommendation text, the set of adaptable passages, the set of recommended characteristics, and the academically formatted list of the specifically relevant scholarly works or specifically relevant recognitions as a draft recommendation letter. Thes system may include providing the draft recommendation letter to a computing device associated with the user in a user editable format configured for the user to finalize and submit to an awards committee.

Implementations of a system for forming a draft recommendation letter for an award may include one, all, or any of the following:

The trained model may be a special purpose model trained to generate the recommendation text.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a diagram of an implementation of a first computer interface;

FIG. 2 is a diagram of an implementation of a third computer interface;

FIG. 3 is a flow chart of an implementation of a method of forming a draft recommendation letter;

FIG. 4 is a block diagram of an implementation of a system for generating a draft recommendations letter for an award; and

FIG. 5 is a flow chart of another implementation of a method of forming a draft recommendation letter.

### DESCRIPTION

This disclosure, its aspects and implementations, are not limited to the specific components, assembly procedures or method elements disclosed herein. Many additional components, assembly procedures and/or method elements known in the art consistent with the intended systems and methods of forming a draft recommendation letter for an award will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such systems and methods of forming a draft recommendation letter for an award, and implementing components and methods, consistent with the intended operation and methods.

Nominating and making recommendations for a colleague or other researcher to receive an academic award has typically been done in an entirely manual and unprompted manner. First, the recommender becomes aware of the existence of a particular award and the criteria under which it is bestowed (frequency, requirements, research achievement requirements, etc.). The recommender then manually drafts a recommendation/nomination letter that outlines how the colleague/researcher meets the requirements and, in many cases, prepares a list of articles/publications prepared by the colleague/researcher and other previously received awards that are relevant to the particular award/requested by the award review committee. This human glue process relies on the abilities of the recommender to obtain the desired information, understand what the award review committee is looking for, and submit the recommendation/nomination by any deadline imposed.

Because of the individual time and effort involved, this manual process inherently reduces the number of awards any particular research will be nominated for and the likelihood that any particular researcher will be awarded the award because of defects in the recommendation letters, and/or defects in the process of creating those letters/documents. It is a lot of work to do, and so the recommender may also simply run of out of time/energy by the time to submit the required materials passes. Furthermore, with the large number of awards out there offered by many different organizations, the ability for any recommender to find the set of potential awards for their colleague that they may qualify for is further reduced. Thus, the ability for researchers to obtain academic awards is limited to those who know recommenders who have the information, time, skill, and energy to do the nominating. This means that many otherwise eligible candidates are simply excluded from consideration.

The system and method implementations disclosed herein help resolving these significant challenges to recognizing those whose scholarship meets the standards of various awards. Because the process does not operate on the “human glue” principle, many more successful nominations of qualified individuals can be carried out which will lead to greater diversity in those who ultimately receive awards. It will be less likely that awards will simply be handed out to those backed by already well connected individuals; rather, awards committees will see properly composed nominations of other scholars including lists of those scholars'past accomplishments being recommended by a greater variety of researchers. All of this combines to make the awarding process more inclusive and a better reflection of what excellence in a particular academic discipline is in reality as awards committees are presented with a more representative sample of scholarship in their discipline.

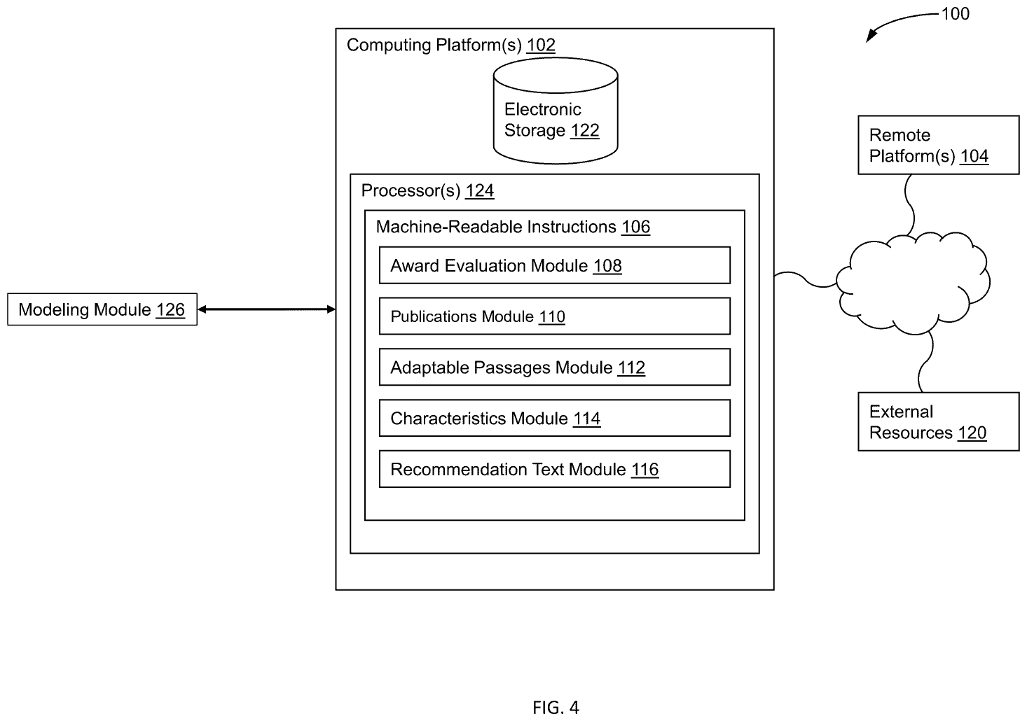

Referring to FIG. 4, an implementation of a system 100 for generating a draft recommendations letter for an award is illustrated. In some implementations, the system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of an award evaluation module 108, a publications module 110, an adaptable passages module 112, a characteristics module 114, and a recommendation text module 116, and/or other instruction modules.

In some implementations, computing platform(s) 102, remote platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 120 may be operatively linked via some other communication media.

A given remote platform 104 may include one or more processors configured to execute computer program modules. The computer program modules may be configured to enable an expert or user associated with the given remote platform 104 to interface with system 100 and/or external resources 120, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

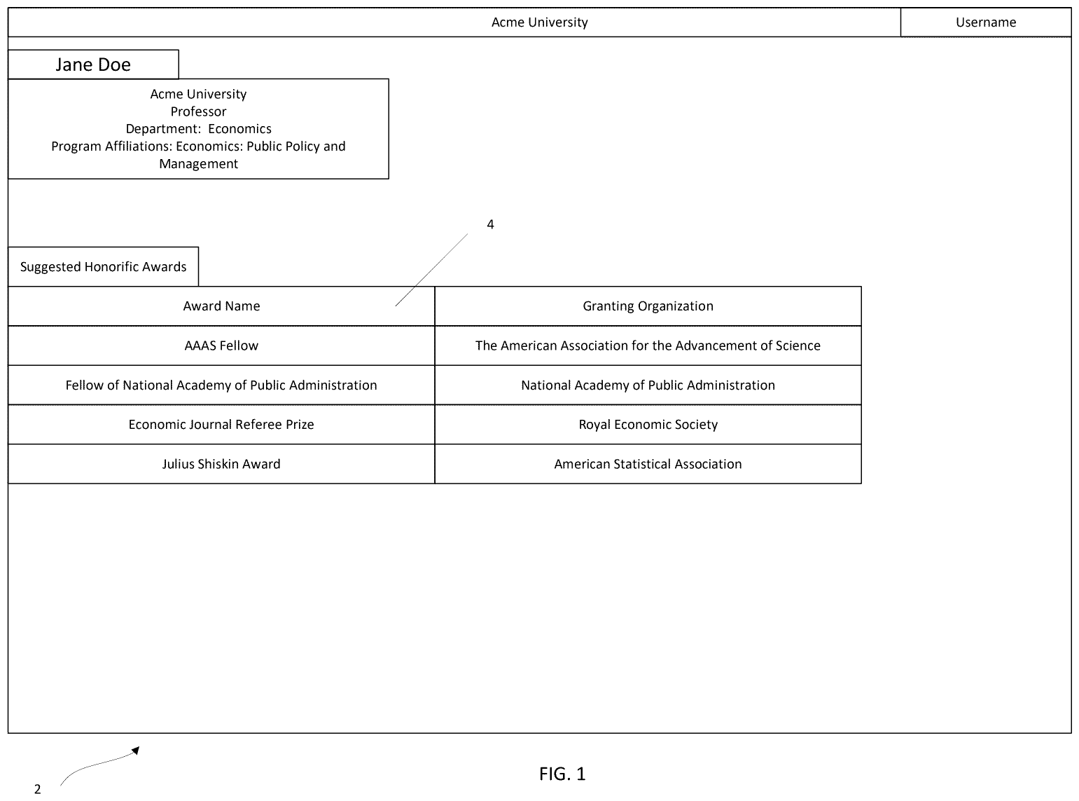

Computing platform(s) 102 may include electronic storage 122, one or more processors 124, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 122 may comprise non-transitory storage media that electronically stores information. The electronic storage media of electronic storage 122 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from computing platform(s) 102, information received from remote platform(s) 104, and/or other information that enables computing platform(s) 102 to function as described herein.

Processor(s) 124 may be configured to provide information processing capabilities in computing platform(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 4 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, and/or 116, and/or other modules. Processor(s) 124 may be configured to execute modules 108, 110, 112, 114, and/or 116, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, and/or 116 are illustrated in FIG. 4 as being implemented within a single processing unit, in implementations in which processor(s) 124 includes multiple processing units, one or more of modules 108, 110, 112, 114, and/or 116 may be implemented remotely from the other modules. The description of the functionality provided by the different modules 108, 110, 112, 114, and/or 116 described below is for illustrative purposes, and is not intended to be limiting, as any of modules 108, 110, 112, 114, and/or 116 may provide more or less functionality than is described. For example, one or more of modules 108, 110, 112, 114, and/or 116 may be eliminated, and some or all of its functionality may be provided by other ones of modules 108, 110, 112, 114, and/or 116. As another example, processor(s) 124 may be configured to execute one or more additional modules that may perform some or all of the functionality attributed below to one of modules 108, 110, 112, 114, and/or 116.

As illustrated in FIG. 4, a modeling module 126 is also include which may be implemented using any of the previously mentioned processor(s), memory, electronic storage 122 and other computing platforms or which may be implemented using another computing systems [such as a cloud computing system that employs graphics processing units (GPUs), tensor processing units (TPUs), central processing units (CPUs), application specific integrated circuits (ASICs), or other microprocessor devices]. In various implementations the cloud computing system may include an existing trained model that the system 100 employs to operate a portion of or all of any of the award evaluation module 108, the publications module 110, adaptable passages module 112, characteristics module 114, and/or recommendations text module 116. In particular implementations, much of or all of the recommendations text module 116 may involve interacting with the modeling module 126 and processing content received from the modeling module 126 including generating one or more interfaces to display the content. In some system implementations, some or all of the components of the modeling module 126 may be a general purpose model operated by a third party, such as, by non-limiting example, the modeling system marketed under the tradename CHATGPT by OpenAI of San Francisco, California; the modeling system marketed under the tradename GEMINI by Google LLC of Menlo Park, California; the modeling system marketed under the tradename LLAMA by Meta Platforms, Inc. of Menlo Park, California; or the modeling system marketed under the tradename ORCA by Microsoft Corporation of Redmond, Washington. In other system implementations, however, the modeling system may contain a special purpose model trained specifically to work with the award database data and to generate draft recommendation letters in formats based on letters that were used for successful awardees in the past. In specific implementations, the trained model may be a large language model. In various system and method implementations, the connection between the modeling module 126 and the system may be made via a prompt and response interface where a prompt is sent to the modeling module 126 and the modeling module 126 then supplies a response to the interface.

The system implementation may be operated in conjunction with various computer interfaces generated by the remote platforms 104 and/or the computing platforms 102. These computer interfaces allow the user to make selections and receive the data of the draft recommendation letter.

Referring to FIG. 1, an implementation of a first computer interface 2 is illustrated. In various system and method implementations, the first computer interface 2 may be generated in response to receiving a selection of a particular researcher. In the first computer interface 2, the researcher's name and then a list of one or more awards 4 that the researcher may qualify for (or is qualified for) is included for review by the user. The user then can select any one of the awards from the list 4 to generate a second computer interface (not shown) and learn more about it (awarding body, frequency with which it is bestowed, discipline, academic age of previous winners, names of previous winners, etc.) and/or evaluate whether the researcher meets various criteria for the award and/or examine a list of the criteria that the system indicates qualifies the researcher for this particular award.

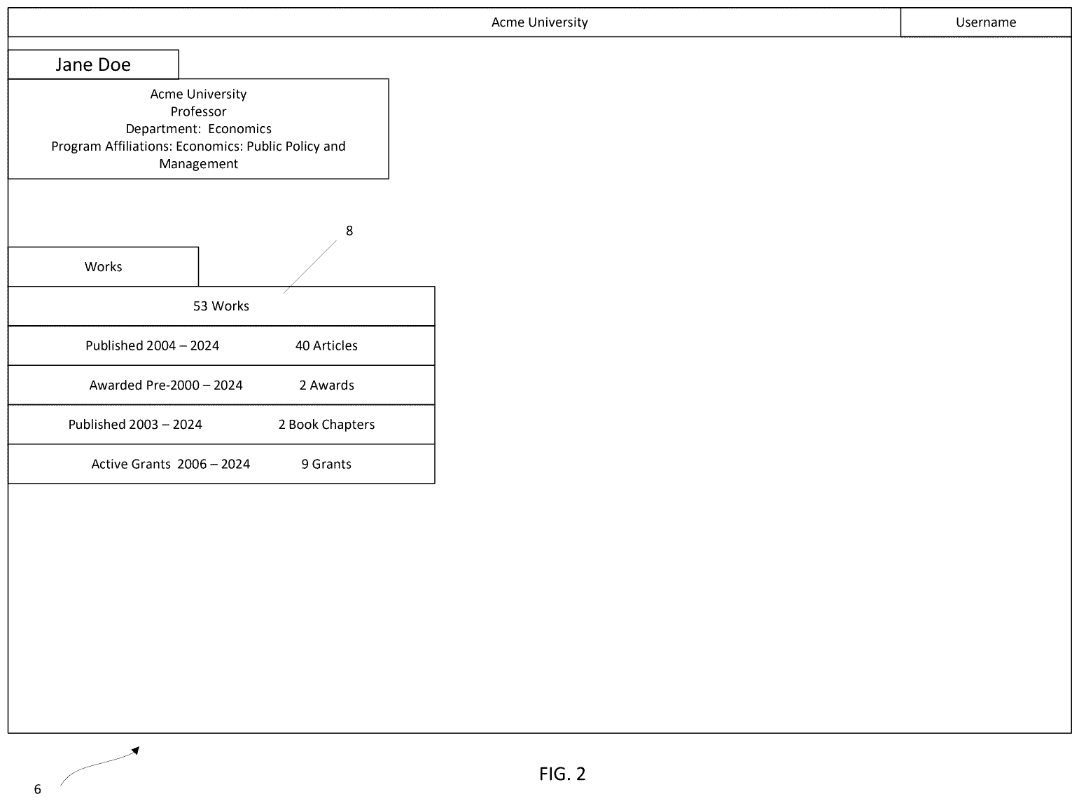

From the second computer interface or first computer interface 2, the user may generate a third computer interface 6 that displays a list 8 of one or more scholarly works and recognitions the researcher has authored/received. An example of a third computer interface is illustrated in FIG. 2. The list of scholarly works and recognitions in the third computer interface may be comprehensive for all time for the researcher selected, or it may include a list of scholarly works and recognitions published/received in a previous period of time (last 5 years, for example) or a list of scholarly works and recognitions that meet certain review or notoriety criteria (articles published in Nature, for example or which scholarly works and recognitions have been most highly cited/widely published). Any of these scholarly works and/or the awards may be displayed/filtered/selected on the basis that they are specifically relevant to one or more awards is the list of one or more awards 4 in particular system and method implementations. Any of a wide variety of criteria/functionality to display information about the scholarly works and recognitions may be included in various interface implementations like those illustrated in FIG. 2. In various implementations, the list 8 of scholarly works and recognitions also includes other information about/relevant to the research activity of the researcher including, by non-limiting example, grants, previous awards, affiliations, academic age, title, position, etc.).

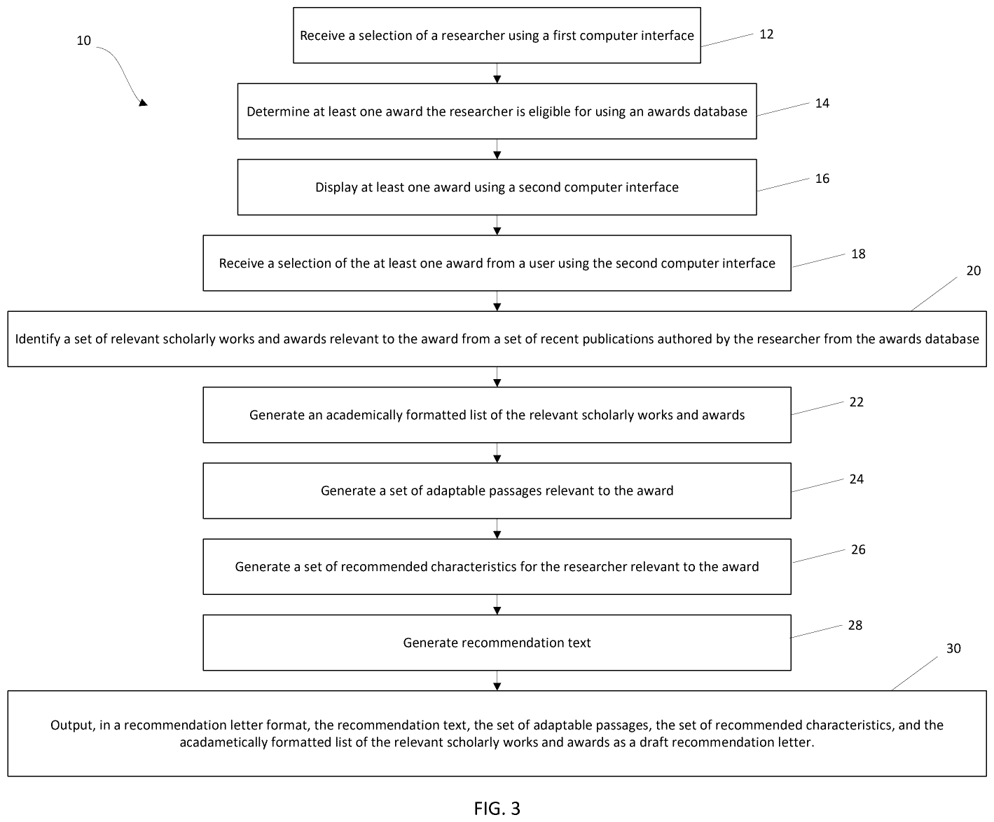

These various system implementations may be utilized in various implementations of a method of forming a draft recommendation letter for an award (honorific award). Referring to FIG. 3, a flow chart of an implementation 10 of such a method is illustrated. As illustrated, the method includes receiving a selection of a researcher using a first computer interface (step 12). In various method implementations, the method includes generating a second computer interface in response to the selection. During the generating, the method includes determining at least one award the researcher is eligible for using an awards database (step 14). The awards database may be included in the electronic storage 122 illustrated in FIG. 4 in various system implementations. As illustrated, the method includes displaying the at least one award the researcher is eligible for using the second computer interface (or first computer interface, step 16). The method also includes receiving a selection of the at least one award from a user using the second computer interface (step 18).

In response to receiving the selection of the of the at least one award, the system utilizes a processor(s) and a trained model from the modeling module 126 illustrated in FIG. 4 to carry out various other processes. As illustrated in FIG. 3, these include identifying a set of relevant scholarly works and recognitions pertinent (specifically relevant) to the selected award from a set of recent scholarly works and recognitions authored by the researcher from the awards database (step 20) and/or from a publications database that is included as part of the system. The method also includes generating an academically formatted list of the relevant scholarly works and recognitions (step 22). The particular format of the list may be any accepted in the particular discipline of the researcher or used by the awards committee including, by non-limiting example, American Psychological Association format (APA), Modern Language Association format (MLA), or any other citation/reference formatting style. The processor(s) and/or trained model also generate a set of adaptable passages relevant to the award (step 24). Non-limiting examples of adaptable passages may include “I have known scholar John Doe for X years” where X is to be customized by the user or “Professor John Doe is a dedicated scholar” where the italics indicate the word “dedicated” is to be adapted as desired by the user.

The processor(s) and/or trained model also, in various implementations, may generate a set of recommended characteristics for the researcher that are relevant to the award (step 26). Non-limiting examples of recommended characteristics may include text that is indicated as a prompt/adaption indicator (italicized, bolded, colored, included in brackets/braces/parentheses) that states what the user could write about that would illustrate a particular recommended characteristic. For example, the prompt could be “Discuss experiences you have had observing the researcher teaching” or “[Include examples of community service you have seen the researcher initiate and lead.]”

At this point, the processor(s) and/or trained model are used to generate recommendation text (step 28). This recommendation text is created in a way that uses language typical of academic letters of recommendation and nomination and is formatted in a way that is also typical of academic letters of recommendation and nomination. With the recommendation text, the processor(s) and/or trained model output, in the recommendation letter format, the recommendation text, the set of adaptable passages, the set of recommended characteristics, and the academically formatted list of the relevant scholarly works and recognitions as a draft recommendation letter (step 30). The academically formatted list may be included as an addendum/appendix to the draft recommendation letter itself or as a separate document/set of text that the user can open/download or copy to be pasted into a word processing program. An example of a draft recommendation letter that includes adaptable passages indicated in braces was filed as Appendix A to the '030 Provisional, the disclosure of which is hereby incorporated entirely herein by reference. This particular draft recommendation letter was generated by the system utilizing a modeling module that employed the large language model marketed under the tradename GEMINI by Google AI of Mountain View, California.

In some implementations, before the recommendation text is generated by the processor(s) and the trained model, the user may be presented with a prompt on the third computer interface that includes the set of adaptable passages and/or the set of recommended characteristics. By being presented in the prompt, the user can edit the set of adaptable passages and/or the set of recommended characteristics before the draft recommendation letter is generated and then submit the edits with the prompt to the recommendation text module (116) and/or the modeling module 126. The resulting output draft recommendation letter from the prompt then may have no or minimal/less additional prompts (adaptable passages/recommended characteristics) for the user to review during the process of examining the letter to finish readying it as a final recommendation/nomination letter ready for submission.

The foregoing system and method implementations are more than merely storing, retrieving, processing, and displaying information because the use of the trained model alters the data in actually learned ways to prepare a draft for ultimate review by the user in the desired style and format desired by a review committee. Nor is the system and method implementation no more than a method of organizing human behavior capable of being performed in the human mind alone because the human mind 1) cannot know and determine all of the possible awards a particular researcher could be nominated for in a given timeframe and 2) the use of the trained model generates a draft that is tailored for the preferences of the review committee that handles that specific award—something many users attempting to draft on their own for the first time simply would be unable to know/learn until after preparing multiple letters—and 3) the recommender may not know or may not reasonably have time to discover the totality of a researcher's published papers and their unique content. Furthermore, the problem of the significant time and effort required of a nominator to manually research all possible awards, review the scholarly works and recognitions of a researcher to determine which are most relevant, and then write a letter that is optimized for consideration by the awards committee including properly formatted citations by the nomination deadline for a given award simply means that a nominator will inherently not have the ability to create nearly as many nominations to deserving researchers that would have the same odds of success as those created using the system and method implementations disclosed herein. Thus, the ability to leverage the trained model to generate optimized content for the award committee and help the user focus on those parts where their experience with the researcher is needed is what helps differentiate the disclosed methods and systems from just methods of organizing human activity and improves the currently technology used to prepare recommendation/nomination letters. The ability to use the system and method implementations disclosed herein also allows academic departments and educational institutions to be able to increase the number of nominations for their researchers and scholars relative to those departments and educational institutions that do not employ the system and method implementations disclosed herein. Thus, these departments and institutions may experience an increase in overall prestige simply because they had more researchers and scholars nominated for awards that other non-using departments and institutions.

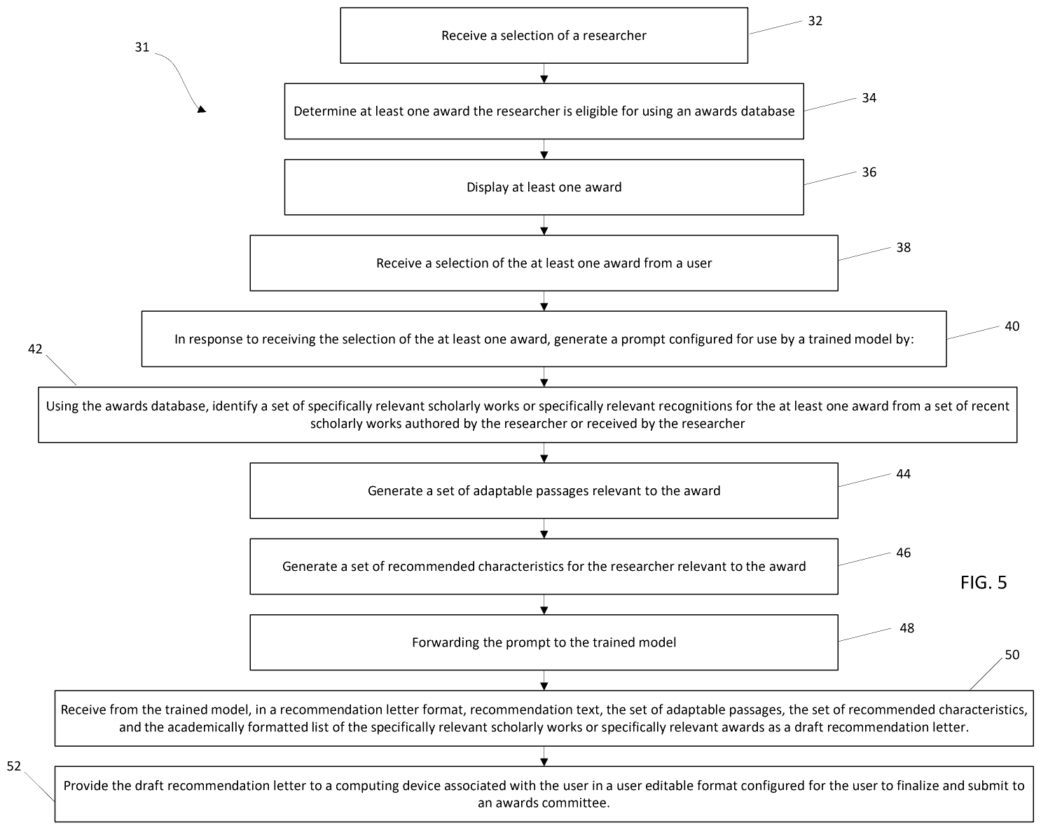

In the previous system and method implementations, the implementations focused on the overall process of creating a draft recommendation letter where the modeling model was part of the overall process/system. In some system and method implementations, the system and method may focus on creating the prompt for sending to a modeling module/trained module and then receiving and processing the output received in response to the prompt from the modeling module/trained module into the desired format. Such systems and methods may be more model agnostic and may enable general purpose models to perform the work of a specially trained model/specialized model adapted just for the task of creating award recommendation letters. Referring to FIG. 5, a flowchart of an implementation of a method of forming a draft recommendation letter for an award (honorific award) 31 is illustrated. The method includes receiving a selection of a researcher (step 32) which may be accomplished using a computing interface associated with a computing device associated with a user. The method also includes determining at least one award the selected researcher is eligible for using an awards database (step 34). This process may be automatically performed by the system, may be manually performed by the user, or may be performed both automatically and manually through a combination of automated filtering and manual review and selection from a list of possible awards. The method includes displaying at least one award (step 36) in a computer interface associated with a computing device of the user and receiving a selection of the at least one award from the user (step 38) which may be done using the computer interface. The method also includes, in response to receiving the selection of the at least one award, generating a prompt configured for use by a trained model (step 40).

In various method implementations, generating the prompt includes using the awards database to identify a set of specifically relevant scholarly works or specifically relevant recognitions of the research for the at least one award from a set of recent scholarly works authored by the researcher or received by the researcher (step 42). Generating the prompt may also include generating a set of adaptable passages relevant to the award (step 44), generating a set of recommended characteristics for the researcher relevant to the award (step 46), and forwarding the assembled prompt to the trained model (step 48). In some implementations, the method may not forward the assembled prompt to the trained model directly, but may display the prompt to the user so the user can review and/or edit the prompt and then supply the prompt to the trained model. The method also includes receiving from the trained model the recommendation text, the set of adaptable passages, the set of recommended characteristics, and the academically formatted list of the specifically relevant scholarly works and/or specifically relevant awards as a draft recommendation letter (step 50). In particular method implementation, these items may be received in a recommendation letter format; in other implementations, the items may be received as output from the particular trained model formatted in the particular model's output format which the user and/or system can then take and format. The method also includes providing the draft recommendation letter in the recommendation letter format to a computing device associated with the user in a user editable format configured for the user to finalized and submit to an awards committee. In various system and method implementations this includes an output in the file format of a particular word processing program or as formatted text designed to be placed into a desired word processing program and then edited by the user.

Implementations of systems and methods like that illustrated in FIG. 5 focus on engineering the prompt so that the output from the trained model can include the formatting and content desired for a specific award. In this way, use of models that are not specifically trained to generate a recommendation letter for a particular award may be used successfully or their output ready for augmentation by further processing by the system to include the needed content and details. A wide variety of method and system implementations for constructing award recommendation letters may be formed using the principles disclosed in this document.

In places where the description above refers to particular implementations of systems and methods of forming a draft recommendation letter for an award and implementing components, sub-components, methods and sub-methods, it should be readily apparent that a number of modifications may be made without departing from the spirit thereof and that these implementations, implementing components, sub-components, methods and sub-methods may be applied to other systems and methods of forming a draft recommendation letter for an award.

What is claimed is:

1. A method of forming a draft recommendation letter for an award, the method comprising:
using a processor, receiving a selection of a researcher using a first computer interface;
determining at least one award the researcher is eligible for using an awards database and the processor;
displaying the at least one award using a second computer interface;
receiving a selection of the at least one award from a user using the second computer interface;
in response to receiving the selection of the at least one award, using the processor and a trained model:
using the awards database, identifying a set of specifically relevant scholarly works or specifically relevant recognitions for the at least one award from a set of recent scholarly works authored by the researcher or received by the researcher;
generating an academically formatted list of the specifically relevant scholarly works or specifically relevant recognitions;
generating a set of adaptable passages relevant to the award;
generating a set of recommended characteristics for the researcher relevant to the award;
generating recommendation text; and
outputting, in a recommendation letter format, the recommendation text, the set of adaptable passages, the set of recommended characteristics, and the academically formatted list of the specifically relevant scholarly works or specifically relevant recognitions as a draft recommendation letter; and
providing the draft recommendation letter to a computing device associated with the user in a user editable format configured for the user to finalize and submit to an awards committee.

2. The method of claim 1, further comprising, in response to a selection from the user on the second computer interface, displaying one or more of the specifically relevant scholarly works or specifically relevant recognitions of the researcher using a third computer interface.

3. The method of claim 1, wherein the trained model is a special purpose model trained to generate recommendation text.

4. The method of claim 1, wherein the trained model is a general purpose model trained to perform the outputting.

5. The method of claim 1, wherein the trained model is a large language model.

6. The method of claim 1, wherein the set of adaptable passages appear in the draft recommendation letter with an adaption indicator to prompt the user to update them.

7. The method of claim 1, wherein the set of recommended characteristics appear in the draft recommendation letter with an adaption indicator to prompt the user to draft content describing one or more of the set of recommended characteristics.

8. The method of claim 1, wherein, before outputting, a third computer interface displays a prompt comprising the set of adaptable passages and the set of recommended characteristics.

9. The method of claim 8, wherein the user customizes the prompt before submitting the prompt for processing by the processor and the trained model to output the recommendation text.

10. A system for forming a draft recommendation letter for an award, the system comprising:
a processor operatively coupled with a memory, the processor and memory configured to:
receive a selection of a researcher using a first computer interface;
determine at least one award the researcher is eligible for using an awards database;
display the at least one award using a second computer interface;
receive a selection of the at least one award from a user using the second computer interface;
in response to receiving the selection of the at least one award, with a trained model:
using the awards database, identify a set of specifically relevant scholarly works or specifically relevant recognitions for the at least one award from a set of recent scholarly works authored by the researcher or received by the researcher;
generate an academically formatted list of the specifically relevant scholarly works or specifically relevant recognitions;
generate a set of adaptable passages relevant to the award;
generate a set of recommended characteristics for the researcher relevant to the award;
generate recommendation text; and
output, in a recommendation letter format, the recommendation text, the set of adaptable passages, the set of recommended characteristics, and the academically formatted list of the specifically relevant scholarly works or specifically relevant recognitions as a draft recommendation letter; and
provide the draft recommendation letter to a computing device associated with the user in a user editable format configured for the user to finalize and submit to an awards committee.

11. The system of claim 10, further comprising, in response to a selection from the user on the second computer interface, displaying one or more of the specifically relevant scholarly works or specifically relevant recognitions of the researcher using a third computer interface.

12. The system of claim 10, wherein the trained model is a special purpose model trained to generate recommendation text.

13. The system of claim 10, wherein the trained model is a general purpose model trained to perform the outputting.

14. The system of claim 10, wherein the trained model is a large language model.

15. The system of claim 10, wherein the set of adaptable passages appear in the draft recommendation letter with an adaption indicator to prompt the user to update them.

16. The system of claim 10, wherein the set of recommended characteristics appear in the draft recommendation letter with an adaption indicator to prompt the user to draft content describing one or more of the set of recommended characteristics.

17. The system of claim 10, wherein, before outputting, a third computer interface displays a prompt comprising the set of adaptable passages and the set of recommended characteristics.

18. The system of claim 17, wherein the user customizes the prompt before submitting the prompt for processing by the processor and the trained model to output the recommendation text.

19. A system for forming a draft recommendation letter for an award, the system comprising:
a processor operatively coupled with a memory, the processor and memory configured to:
receive a selection of a researcher;
determine at least one award the researcher is eligible for using an awards database;
display the at least one award;
receive a selection of the at least one award from a user;
in response to receiving the selection of the at least one award, generating a prompt configured for use by a trained model by:
using the awards database, identifying a set of specifically relevant scholarly works or specifically relevant recognitions for the at least one award from a set of recent scholarly works authored by the researcher or received by the researcher;
generating an academically formatted list of the specifically relevant scholarly works or specifically relevant recognitions;
generating a set of adaptable passages relevant to the award; and
generating a set of recommended characteristics for the researcher relevant to the award; and
forwarding the prompt to the trained model; and
receive from the trained model, in a recommendation letter format, recommendation text, the set of adaptable passages, the set of recommended characteristics, and the academically formatted list of the specifically relevant scholarly works or specifically relevant recognitions as a draft recommendation letter; and
provide the draft recommendation letter to a computing device associated with the user in a user editable format configured for the user to finalize and submit to an awards committee.

20. The system of claim 19, wherein the trained model is a special purpose model trained to generate the recommendation text.
